(19) United States
(12) Patent Application Publication
(10) Pub. No.: US 2024/0220207 A1
(43) Pub. Date: Jul. 4, 2024

(54) ELECTRONIC DEVICES, CONNECTION CONTROL METHODS, AND RECORDING MEDIUM

(71) Applicant: CASIO COMPUTER CO., LTD., Tokyo (JP)

(72) Inventor: Hiroaki YOSHIZAWA, Tokyo (JP)

(73) Assignee: CASIO COMPUTER CO., LTD., Tokyo (JP)

(21) Appl. No.: 18/401,427

(22) Filed: Dec. 30, 2023

(30) Foreign Application Priority Data
Jan. 4, 2023 (JP) 2023-000215

(51) Int. Cl. G06F 7/57; G06F 3/0362; H04W 76/10

(52) U.S. Cl. CPC G06F 7/57; G06F 3/0362; H04W 76/10

(57) ABSTRACT

An electronic device includes a switch having an operator that can assume one of a plurality of positions; a wireless communication unit; and a control unit, wherein in response to detecting that a position of the operator is switched, the control unit selects an external device associated with the switched position of the operator from among a plurality of external devices and establishes a connection to the selected external device via the wireless communication unit.

### BACKGROUND OF THE INVENTION

### Technical Field

The present disclosure relates to an electronic device, a connection control method, and a recording medium.

### Background Art

Conventionally, as described in Japanese Unexamined Patent Application Publication No. 2014-230277, a technique is known in which a connection destination is displayed on a display means in a keyboard that can be wirelessly connected to a plurality of external devices.

### SUMMARY OF THE INVENTION

Features and advantages of the invention will be set forth in the descriptions that follow and in part will be apparent from the description, or may be learned by practice of the invention.

The objectives and other advantages of the invention will be realized and attained by the structure particularly pointed out in the written description and claims thereof as well as the appended drawings.

To achieve these and other advantages and in accordance with the purpose of the present invention, as embodied and broadly described, in one aspect, the present disclosure provides an electronic device, comprising: a switch having an operator that can assume one of a plurality of positions; a wireless communication unit; and a control unit, wherein in response to detecting that a position of the operator is switched, the control unit selects an external device associated with the switched position of the operator from among a plurality of external devices and establishes a connection to the selected external device via the wireless communication unit.

In another aspect, the present disclosure provides a method to be performed by a control unit in an electronic device that includes, in addition to the control unit, a switch having an operator that can specify one of a plurality of positions; and a wireless communication unit, the method comprising, via the control unit: in response to detecting that a position of the operator is switched, selecting an external device associated with the switched position of the operator from among a plurality of external devices; and establishing a connection to the selected external device via the wireless communication unit.

In another aspect, the present disclosure provides a non-transitory computer readable storage medium storing a program to be performed by a control unit in an electronic device that includes, in addition to the control unit, a switch having an operator that can specify one of a plurality of positions; and a wireless communication unit, the program causing the control unit to perform the following: in response to detecting that a position of the operator is switched, selecting an external device associated with the switched position of the operator from among a plurality of external devices; and establishing a connection to the selected external device via the wireless communication unit.

It is to be understood that both the foregoing general description and the following detailed description are exemplary and explanatory, and are intended to provide further explanation of the invention as claimed.

### BRIEF DESCRIPTION OF THE DRAWINGS

FIG. 1 is a block diagram showing a configuration of an electronic device (calculator) 1 of an embodiment.

FIG. 2A is an external front view of the electronic device 1 according to this embodiment.

FIG. 2B is a schematic diagram showing the appearance of the slide switch 121 of the key input unit 12 of the electronic device 1.

FIG. 3 is a conceptual diagram showing the configuration of a connection destination table in the electronic device (calculator) 1 of this embodiment.

FIG. 4 is a flowchart showing the operation (main processing) of the electronic device (calculator) 1 of this embodiment.

FIG. 5 is a flowchart showing the operation (advertisement processing) of the electronic device (calculator) 1 of this embodiment.

FIG. 6A is a schematic diagram showing an operation procedure and display example (Example 1) in the electronic device (calculator) 1 of this embodiment.

FIG. 6B is a schematic diagram showing the operation procedure and display example (Example 1) in the electronic device (calculator) 1 of this embodiment.

FIG. 6C is a schematic diagram showing the operation procedure and display example (Example 1) in the electronic device (calculator) 1 of this embodiment.

FIG. 6D is a schematic diagram showing the operation procedure and display example (Example 1) in the electronic device (calculator) 1 of this embodiment.

FIG. 6E is a schematic diagram showing the operation procedure and display example (Example 1) in the electronic device (calculator) 1 of this embodiment.

FIG. 6F is a schematic diagram showing the operation procedure and display example (Example 1) in the electronic device (calculator) 1 of this embodiment.

FIG. 6G is a schematic diagram showing the operation procedure and display example (Example 1) in the electronic device (calculator) 1 of this embodiment.

FIG. 6H is a schematic diagram showing the operation procedure and display example (Example 1) in the electronic device (calculator) 1 of this embodiment.

FIG. 7A is a schematic diagram showing another operation procedure and display example (Example 2) in the electronic device (calculator) 1 of an embodiment.

FIG. 7B is a schematic diagram showing the operation procedure and display example (Example 2) in the electronic device (calculator) 1 of this embodiment.

FIG. 7C is a schematic diagram showing the operation procedure and display example (Example 2) in the electronic device (calculator) 1 of this embodiment.

FIG. 7D is a schematic diagram showing the operation procedure and display example (Example 2) in the electronic device (calculator) 1 of this embodiment.

FIG. 7E is a schematic diagram showing the operation procedure and display example (Example 2) in the electronic device (calculator) 1 of this embodiment.

FIG. 7F is a schematic diagram showing the operation procedure and display example (Example 2) in the electronic device (calculator) 1 of this embodiment.

FIG. 7G is a schematic diagram showing the operation procedure and display example (Example 2) in the electronic device (calculator) 1 of this embodiment.

FIG. 7H is a schematic diagram showing the operation procedure and display example (Example 2) in the electronic device (calculator) 1 of this embodiment.

### DETAILED DESCRIPTION OF EMBODIMENTS

### Embodiments

The preferred embodiments for carrying out the present disclosure will be described below with reference to the drawings. However, although the embodiments described below have various limitations that are technically preferable for carrying out the present disclosure, the scope of the invention is not limited to the embodiments and illustrated examples below.

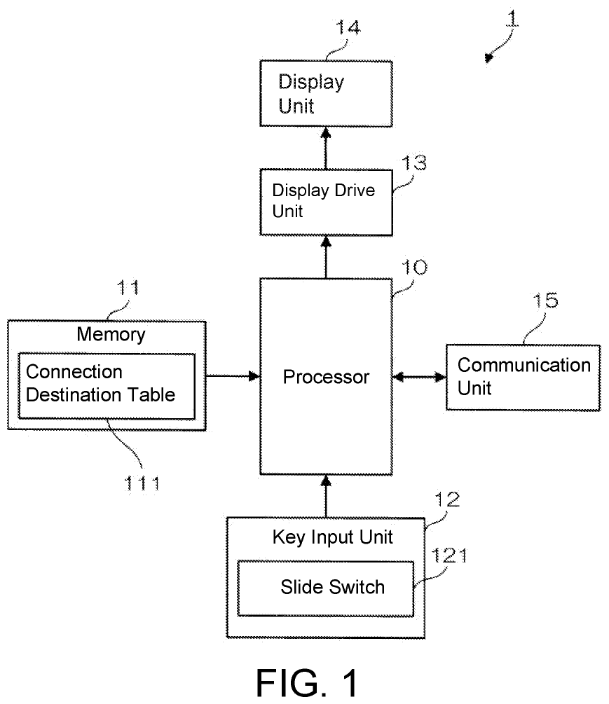

FIG. 1 is a block diagram showing the configuration of an electronic device (calculator) 1 of this embodiment. The electronic device 1 includes a processor 10 (control unit), a memory 11, a key input unit 12, a display drive unit 13, a display unit 14, and a communication unit 15.

The electronic device 1 is a desktop calculator, so-called a portable calculator, but it may be any other type of electronic device having a numerical calculation function other than a calculator. Further, the electronic device 1 may have a configuration other than that shown in FIG. 1.

The processor 10 is a processor (control unit) that controls various operations of the electronic device 1. Processor 10 may be a CPU, ASIC, FPGA, etc. Further, the processor 10 may be composed of two or more processors. The processor 10 operates as a determination unit that determines whether specific operation keys of the key input unit 12 are operated. Further, the processor 10 executes various processes (such as arithmetic processing) in response to operations of various operation keys included in the key input unit 12. In particular, in this embodiment, the processor 10 connects to the external device 200 via wireless communication by the communication unit 15 and performs data communication so that the keys of (a part of) the key input unit 12 of the electronic device 1 can be used as a numeric keypad.

The memory 11 includes RAM and ROM. RAM is volatile memory. The RAM is used as a working memory for temporarily storing various data in the processor 10 and a frame memory for displaying input numerical values, operators, and calculation results on the display unit 14, and the like. In particular, in this embodiment, the memory 11 stores a connection destination table 111 in which switching positions of an operator (contact point) of a slide switch 121, which will be described later, are associated with pairing information of external devices to be connected. ROM is a nonvolatile memory. The ROM stores various programs such as a calculation program for executing various electronic device functions, a communication control program, and a connection control program.

The key input unit 12 has various keys for the user to operate the electronic device 1. When an operation using the key input unit 12 is accepted, an input signal corresponding to the operation is transmitted to the processor 10. In particular, in this embodiment, the existing slide switch 121 of the key input unit 12 is used to select an external device to be connected from among a plurality of external devices based on the switching position of the operator (contact) of the slide switch 121. The structure of the slide switch 121 will be described later.

The display drive unit 13 drives the display unit 14 under the control of the processor 10. The display drive unit 13 sends various signals necessary for driving the display unit 14 to the display unit 14. The display unit 14 is a 7-segment display such as a liquid crystal display, and performs various displays related to the calculator function. The communication unit 15 applies Bluetooth (registered trademark) low energy (hereinafter simply referred to as wireless communication) communication, which is a wireless communication standard with low power consumption, and as shown in FIG. 1, performs bidirectional data communication using the electronic device 1 as a slave (peripheral) side terminal and an external device, as a master (central) side terminal.

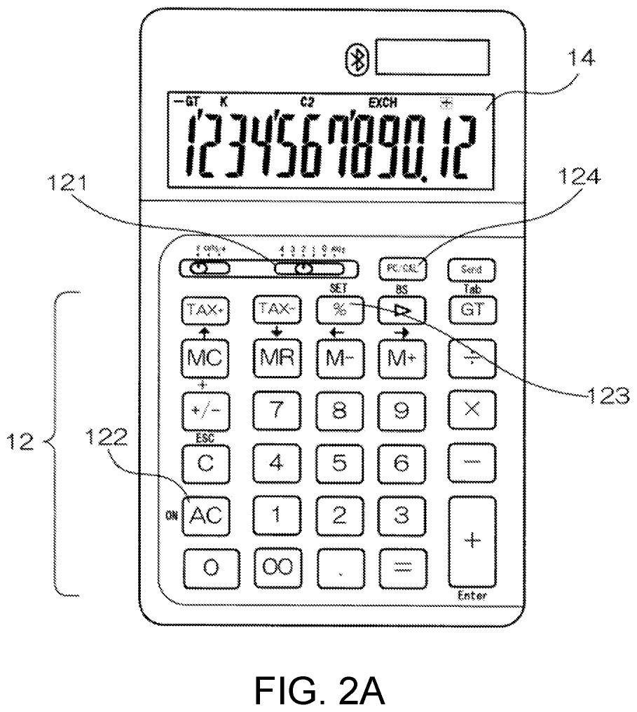

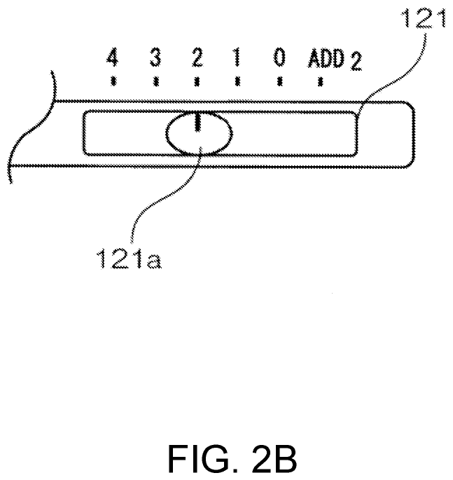

FIG. 2A is an external front view of the electronic device 1 according to the present embodiment, and FIG. 2B is a schematic diagram showing the external appearance of the slide switch 121 of the key input unit 12 of the electronic device 1. As shown in FIG. 2A, a key input unit 12 and a display unit 14 are provided on the front of the housing of the electronic device 1. The key input unit 12 includes numerical keys, calculation keys, function keys, and the like. The numerical keys are keys for inputting numerical values, and include, for example, keys corresponding to 00 and each numerical value from 0 to 9. The calculation keys are keys for performing four arithmetic operations, such as operator keys corresponding to the operators+ (addition), − (subtraction), × (multiplication), and ÷ (division), and the equal key=(calculation execution). The function keys are keys for implementing various functions of the electronic device 1, and include, for example, the AC key (all clear key) 122, the C key (clear key), the MRC key, the M+ key, and the M− key (memory key), SET (%) key 123, and PC/CAL key 124.

In particular, the PC/CAL key 124 is used to specify whether the electronic device 1 is operated in PC mode or CAL mode. The PC mode is a mode in which the electronic device 1 is connected to an external device by wireless communication and operates as a slave terminal (numeric keypad) with respect to the external device (master terminal). The CAL mode is a mode in which the electronic device 1 operates as a calculator.

As shown in FIG. 2B, the slide switch 121 is an existing known switch for specifying the number of digits for rounding a calculation result in the CAL mode, and is also called a decimal point selector. The illustrated slide switch 121 has five contacts (switching positions), and by moving the operator 121a to any one of switching positions “4”, “3”, “2”, “1”, and “0”, the user can specify how many digits to the right of the decimal point should be calculated in the calculation result. Further, “ADD2” is for automatically displaying the decimal point at the second decimal place even if the key “.” is not pressed.

In this embodiment, in the PC mode, the existing slide switch 121 is used to specify an external device to be connected. Specifically, when the user moves the operator 121a of the slide switch 121 to the “4” switching position in the PC mode, the processor 10 causes an external device registered in association with the “4” switching position to be automatically connected. Further, when the user moves the operator 121a of the slide switch 121 to the switching position “3”, the processor 10 causes an external device registered in association with the switching position “3” to be automatically connected. Similarly, when the operator 121a of the slide switch 121 is moved to the switching position “2”, an external device associated with the switching position “2” is connected; when it is moved to the switching position “1”, an external device associated with the switching position “1” is connected; and when it is moved to the switching position “0”, an external device associated with the switching position “0” is connected. In this way, since the switching position of the operator 121a of the slide switch 121 directly indicates the external device to be connected, the user can easily specify the external device to be connected. Also, by simply observing the switching position of the operator 121a of the switch 121, it is possible to confirm which external device is connected.

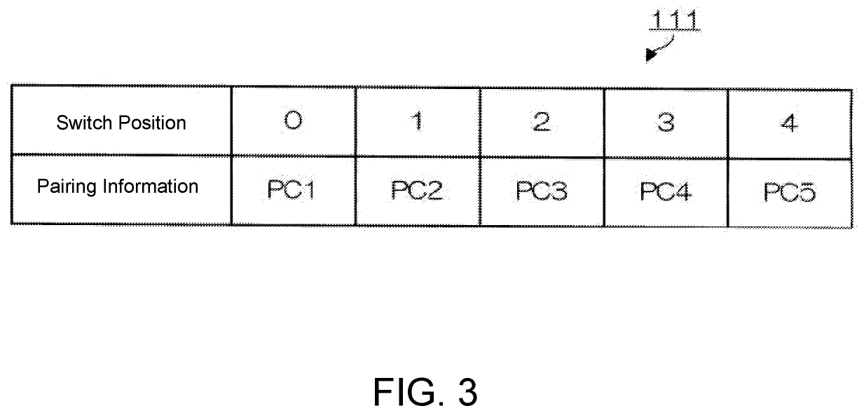

FIG. 3 is a conceptual diagram showing the configuration of the connection destination table 111 in the electronic device (calculator) 1 of this embodiment. In this embodiment, as described above, settings are made such that the switching position of the operator 121a of the slide switch 121 and the pairing information of the external device to be connected are associated with each other and set in the connection destination table 111. As shown in FIG. 3, in the connection destination table 111, pairing information with an external device for wireless communication is set for each switching position of the operator 121a of the slide switch 121. In the illustrated example, pairing information for “PC1” as an external device is set to “0” of the slide switch 121, and pairing information for “PC2” as an external device is set to “1” of the slide switch 121. Similarly, pairing information for “PC3” is set to “2” of the operator 121a of the slide switch 121, pairing information for “PC4” is set to the switching position “3”, and pairing information for “PC5” is set to the switching position “4” of the slide switch 121. Note that the switching position of the operator 121a of the slide switch 121 and the external device to be connected can be changed (re-registered, canceled, etc.) at any time.

FIG. 4 is a flowchart showing the operation (main processing) of the electronic device (calculator) 1 of this embodiment. The user presses the PC/CAL key 124 when changing from the CAL mode to the PC mode where the electronic device (calculator) 1 is used as a numeric keypad for an external device, or when changing from the PC mode to the CAL mode where the electronic device (calculator) 1 is used as a calculator.

The processor 10 detects the state of the PC/CAL key 124 and determines whether it is in the PC mode (step S10), and if it is not in the PC mode, that is, in the CAL mode (NO in step S10), the CAL mode (calculator) operation is executed (step S12).

On the other hand, if it is the PC mode (YES in step S10), the processor 10 determines whether the SET key 123 has been pressed for a long time (for example, continuously for 2 seconds or more) (step S14). Then, the processor 10 waits until it is determined that the SET key 123 has been pressed for a long time (NO in step S14), and when it is determined that the SET key has been pressed for a long time (YES in step S14), the processor 10 starts the advertisement process for pairing with an external device (step S16). Note that details of the advertisement process will be described later.

Prior to or during the advertisement process, the user slides the operator 121a of the slide switch 121 to a switching position associated with an external device to be paired. In the advertisement process, the processor 10 performs pairing with the external device associated with the detected switching position of the operator 121a of the slide switch 121.

As described above, the operator 121a of the slide switch 121 can be changed during advertisement processing. However, no matter which switching position the operator 121a of the slide switch 121 is set, there is a possibility that pairing with any external device may not be possible. Therefore, when the advertisement process is completed, the processor 10 determines whether or not it has been paired with the external device associated with the current switching position of the operator 121a of the slide switch 121, that is, whether it is currently paired with any external device (step S18).

Then, if it is determined that it has not been paired with an external device, that is, if the pairing is not successful (NO in step S18), the process returns to step S16 and the advertisement process is executed again.

On the other hand, if it is determined that pairing has been made with the external device associated with the current switching position of the operator 121a of the slide switch 121 (YES in step S18), the processor 10 selects the PC mode (numeric keypad) operation (step S20). More specifically, when a key on the key input unit 12 of the electronic device (calculator) 1 is pressed, the code of the key is sent to an external device via wireless communication, thereby allowing the electronic device (calculator) 1 to be used as a numeric keypad (keyboard).

Next, the processor 10 acquires the switching position of the operator 121a of the slide switch 121 (step S22), and compares the current switching position of the operator 121a of the slide switch 121 and the previous switching position of the operator 121a of the slide switch 121 (step S24).

If the current switching position and the previous switching position are different (“different” in step S24), the processor 10 returns to step S16, executes the advertisement process again in order to pair itself with the external device associated with the current switching position. In other words, when the switching position of the operator 121a of the slide switch 121 is changed, the advertisement process is executed again, and the pairing with the external device associated with the current switching position of the operator 121a of the slide switch 121 is performed. If the pairing with the new external device is successful, the processor 10 executes the PC mode (numeric keypad) operation for the new external device in step S20.

On the other hand, if the current switching position and the previous switching position are the same (“same” in step S24), the processor 10 detects the state of the PC/CAL key 124 and determines whether or not it is in the CAL mode. If the processor 10 determines that it is not in the CAL mode (step S26), that is, if the PC mode is continued (NO in step S26), the processor 10 returns to step S18 and repeats the above-described process.

On the other hand, if the user switches from the PC mode to the CAL mode (YES in step S26), the processor 10 determines this, cancels the pairing with the external device (step S28), and returns to step S12, thereby executing the CAL mode (calculator) operation.

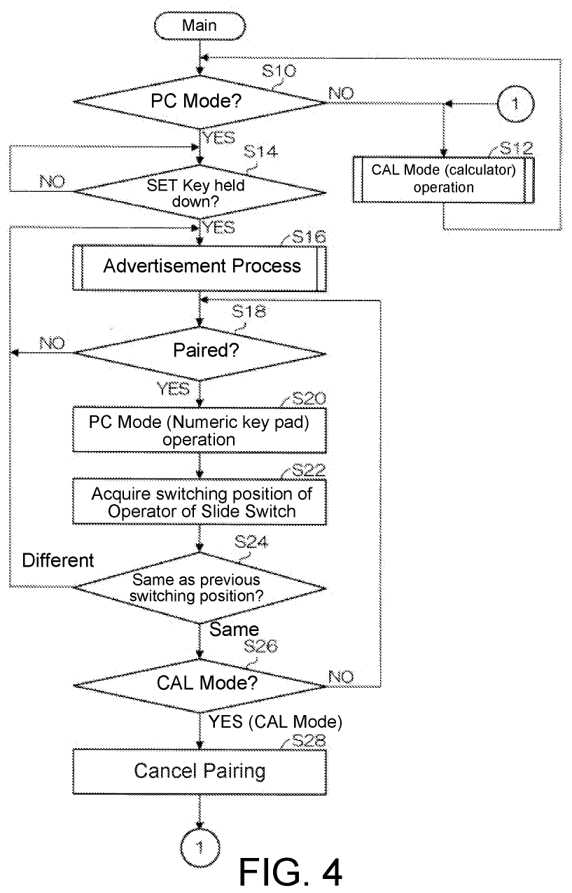

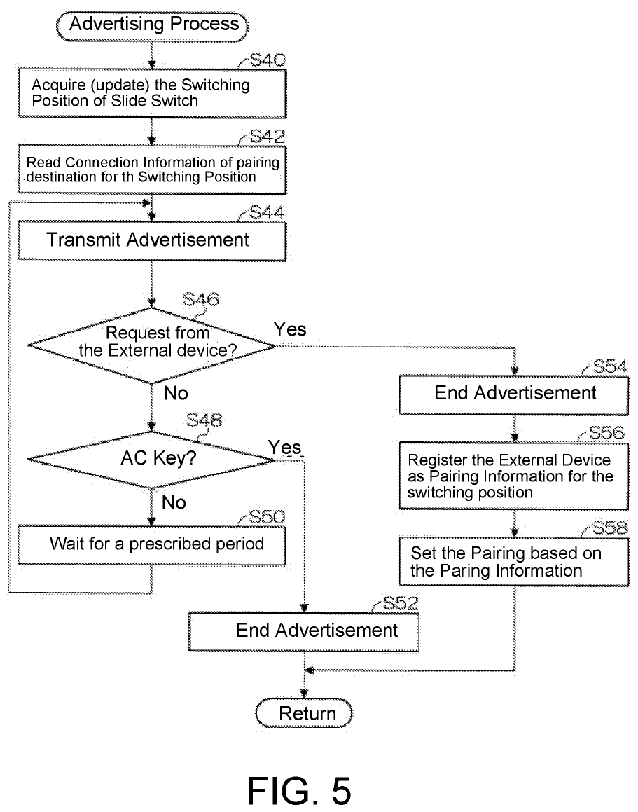

FIG. 5 is a flowchart showing the operation (advertisement process) of the electronic device (calculator) 1 of this embodiment. In the advertisement process, the processor 10 acquires the switching position of the operator 121a of the slide switch 121 (step S40), and reads the pairing information of the external device associated with the current switching position of the operator 121a of the slide switch 121 as the connection target from the connection destination table 111 (step S42). Next, the processor 10 transmits an advertisement (step S44), and determines whether there is a pairing request from an external device corresponding to the read pairing information (step S46).

Here, if it is determined that there is no pairing request from the external device to be connected (“no” in step S46), the processor 10 determines whether the AC key 122 has been pressed (step S48). If it is determined that the AC key 122 has not been pressed (“no” in step S48), the processor 10 waits for a predetermined time (step S50), returns to step S44, and sends the advertisement again. The advertisement transmission is repeated until the depression of the AC key 122 by the user is detected.

If a pairing request is not detected from the external device to be connected and a press of the AC key 122 by the user is detected (“Yes” in step S48), the processor 10 ends the advertisement (step S52), and the process returns to the above-mentioned main process (step S18). In this case, the user can either change the switching position of the operator 121a of the slide switch 121 and try pairing with a different external device, or press the PC/CAL key 124 to exit the PC mode and return to the CAL mode.

On the other hand, if it is determined that there is a pairing request from an external device corresponding to the read pairing information (“Yes” in step S46), the processor 10 ends the transmission of advertisement (step S54). The pairing information of the external device to be connected is registered in the connection destination table 111 in association with the current switching position of the operator 121a of the slide switch 121 (step S56). Next, the processor 10 sets the pairing with the external device to be connected (step S58), and returns to the above-described main process (step S18). If it is determined that the pairing with the external device to be connected is successful, the processor 10 executes the PC mode (numeric keypad) operation on the paired external device in step S20.

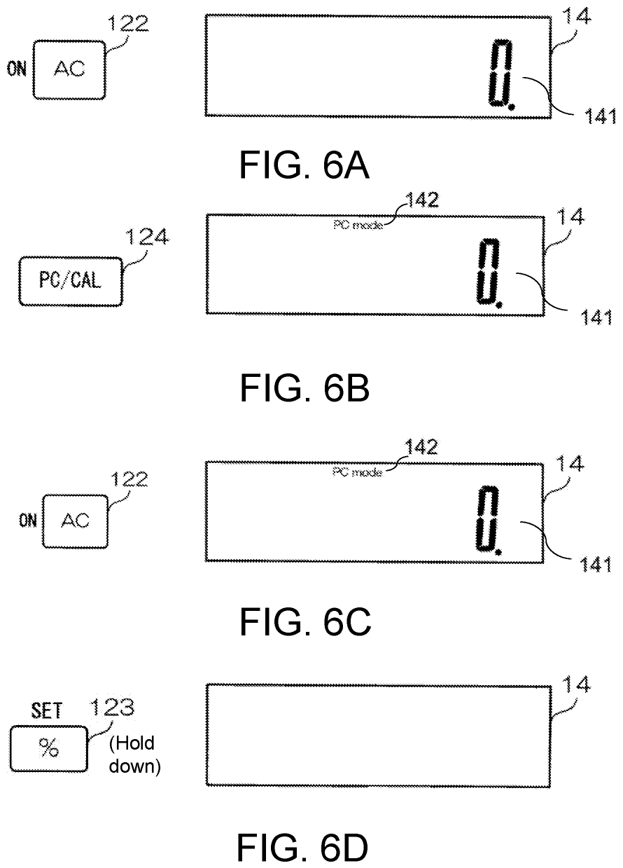

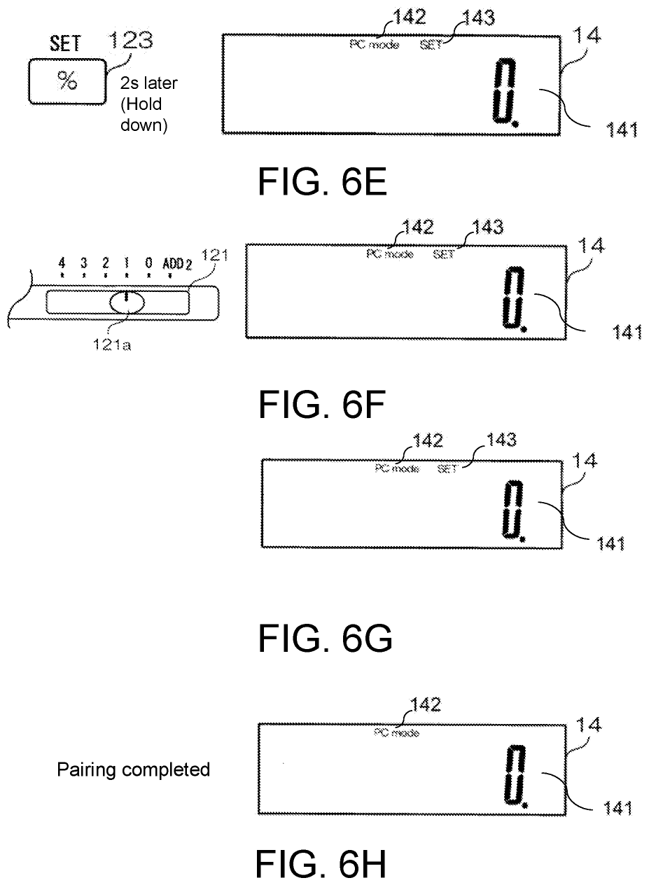

FIGS. 6A to 6H are schematic diagrams showing operation procedures and display examples (Example 1) in the electronic device (calculator) 1 of the present embodiment. As shown in FIG. 6A, when the user presses the AC key 122 in the CAL mode, all contents are cleared and “0.” is displayed in the numerical display area 141 of the display unit 14. Next, as shown in FIG. 6B, when the user presses the PC/CAL key 124, “PC mode” is displayed in the segment display area 142 of the display unit 14, indicating that the mode has changed to the PC mode. By displaying “PC mode” in the segment display area 142, the user can visually confirm that the current mode is the PC mode.

Next, as shown in FIG. 6C, when the user presses the AC key 122, “0.” is displayed in the numerical display area 141 of the display unit 14. Then, as shown in FIG. 6D, when the user presses the SET key 123 for a long time, the display screen of the display unit 14 is turned off during the long press, and after the long press (for example, after 2 seconds), as shown in FIG. 6E, “PC mode” is displayed in the segment display area 142 of the display unit 14, “SET” is displayed in the segment display area 143, and “0.” is displayed in the numerical display area 141. Thereby, the user can know that the PC mode is currently in progress and that the advertisement process is in progress by “SET” displayed in the segment display area 143.

At this time, as shown in FIG. 6F, if the user has been setting the operator 121a of the slide switch 121 to “1”, the processor 10 sends an advertisement and sets the pairing based on the pairing information of the external device corresponding to “1”. During this time, as shown in FIG. 6G, “PC mode” is displayed in the segment display area 142 of the display unit 14, “SET” is displayed in the segment display area 143, and “0.” is displayed in the numerical display area 141. Furthermore, during the advertisement transmission and pairing setting, the user may move the operator 121a of the slide switch 121 to a different switching position, that is, a switching position corresponding to a different external device as a pairing destination, if necessary.

Then, as shown in FIG. 6H, when the pairing setting is completed, the display of “SET” in the segment display area 143 on the display unit 14 disappears, and the display of “PC mode” in the segment display area 142 and display of “0.” in the numerical display area 141 continue. The user can know that the pairing was successful when the display of “SET” disappears in the segment display area 143 on the display unit 14.

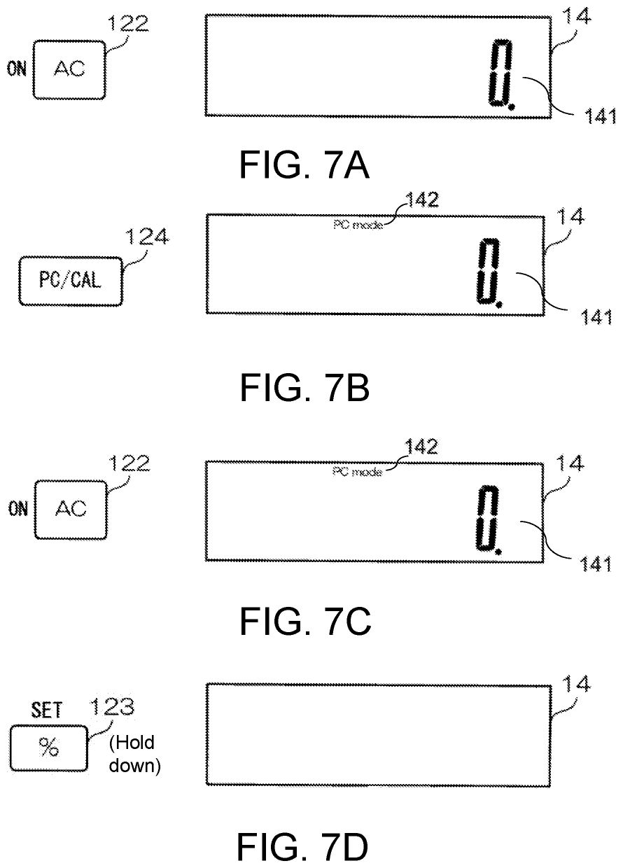

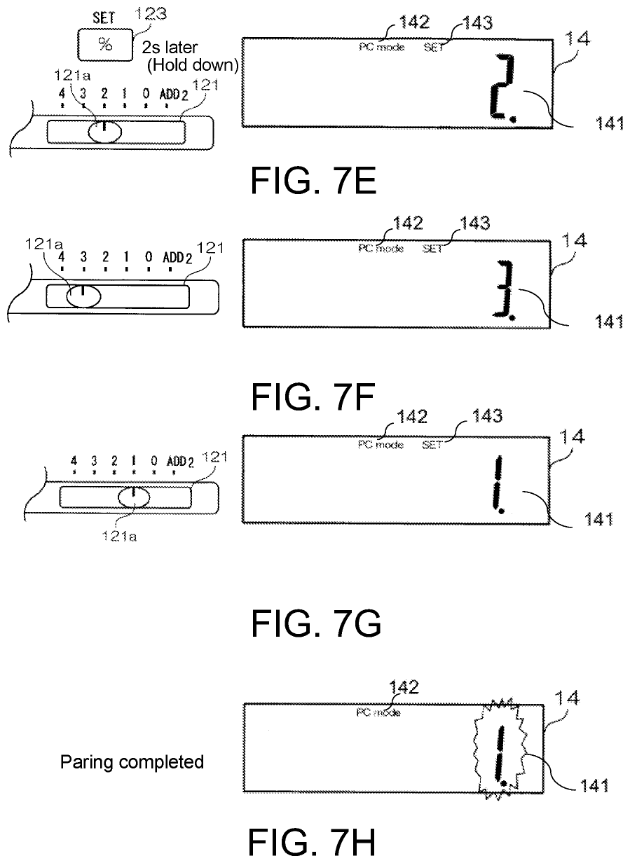

FIGS. 7A to 7H are schematic diagrams showing another operation procedure and display example (Example 2) in the electronic device (calculator) 1 of an embodiment. FIGS. 7A to 7H show an example of display and operation when the user moves the operator 121a of the slide switch 121 to different switching positions, that is, switching positions corresponding to different external devices as the pairing destinations, during advertisement transmission and pairing setting. Further, in the display examples shown in FIGS. 7A to 7H, the switching position of the operator 121a of the slide switch 121 is displayed as a numerical value in the numerical display area 141 of the display unit 14.

As shown in FIG. 7A, when the user presses the AC key 122 in the CAL mode, all contents are cleared and “0.” is displayed in the numerical display area 141 of the display unit 14. Next, as shown in FIG. 7B, when the user presses the PC/CAL key 124, “PC mode” is displayed in the segment display area 142 of the display unit 14, indicating that the mode has changed to the PC mode. By displaying “PC mode” 142 in the segment display area 142 in this manner, the user can visually recognize that the PC mode is currently in effect.

Next, as shown in FIG. 7C, when the user presses the AC key 122, “0.” is displayed in the numerical display area 141 of the display unit 14. Then, as shown in FIG. 7D, when the user presses the SET key 123 for a long time, the display screen of the display unit 14 is turned off during the long press, and after the long press (for example, after 2 seconds), as shown in FIG. 7E, “PC mode” is displayed in the segment display area 142 of the display unit 14, “SET” is displayed in the segment display area 143, and the current switching position of the operator 121a of the slide switch 121 (at this time, assume that it is in the switching position “2”), “2.” is displayed in the numerical display area 141. Thereby, the user can know that the PC mode is currently in progress and that the advertisement process for pairing with the external device corresponding to the switching position “2” of the operator 121a is in progress. At this time, the processor 10 sends an advertisement and sets the pairing based on the pairing information of the external device corresponding to “2”.

During the advertisement process, as shown in FIG. 7F, when the user moves the operator 121a of the slide switch 121 to “3”, “PC mode” is displayed in the segment display area 142, “SET” is displayed in the segment display area 143, and at the same time, “3.” is displayed in the numerical display area 141 of the display unit 14. At this time, the processor 10 sends an advertisement and sets pairing based on the pairing information of the external device corresponding to “3”.

Furthermore, as shown in FIG. 7G, when the user moves the operator 121a of the slide switch 121 to “1”, “PC mode” is displayed in the segment display area 142, “SET” is displayed in the segment display area 143, and at the same time, “1.” is displayed in the numerical display area 141. At this time, the processor 10 sends an advertisement and sets pairing based on the pairing information of the external device corresponding to “1”.

When the pairing setting is completed, the “SET” display that was displayed in the segment display area 143 of the display unit 14 disappears, and “1.” indicating the position of the operator 121a of the slide switch 121 when the pairing is finally completed is displayed in the numerical display area 141. By the fact that the display of “SET” disappears from the segment display area 143 of the display unit 14 and “1” is displayed in the numerical display area 141, the user can confirm that the pairing with the external device corresponding to “1” has been successful.

In addition, as shown in FIG. 7H, when the pairing setting is completed, “1.” indicating the switching position of the operator 121a of the slide switch 121 at the time of final pairing may be blinking. By the fact that the display of “SET” disappears from the segment display area 143 of the display unit 14 and “1” blinks in the numerical display area 141, the user can more clearly understand that the pairing with the external device corresponding to “1” was successful.

In the embodiments described above, the slide switch 121 that slides the operator 121a is used to specify the external device to be connected via wireless communication, but the present invention is not limited to this, and any existing switch in the electronic device (calculator) may be used; for example, a rotary switch that rotates an operator, or a push switch provided for each option (in which holding down is possible) may be used.

In the embodiments described above, in response to detecting that the position of the operator 121a is switched, the processor 10 selects an external device associated with the switched position of the operator 121a from among a plurality of external devices, and causes the external device to be connected via the communication unit 15. Therefore, it is possible to more easily select an external device to which connection is desired from a plurality of external devices without adding additional hardware.

According to the embodiments described above, in response to detecting that the switching position of the operator 121a of the slide switch 121 is changed during connection, the processor 10 determines which external device is connected based on the changed switching position. Since the connection is made by selecting a different external device based on the changed switching position, it is possible to easily change the external device to be connected without adding additional hardware, and it is also possible to easily identify the external device to be connected.

According to the embodiments described above, a plurality of switching positions and pairing information of external devices to be connected are stored in association with each other in the connection destination table 111, and the processor 10 reads out the pairing information associated with the switching position of the operator 121a of the slide switch 121 from the connection destination table 111 so as to connect to an external device based on the read pairing information. Therefore, the user can easily select an external device to which the user wishes to connect among the plurality of external devices without adding additional hardware.

According to the embodiments described above, as a way for specifying an external device to be connected, an existing slide switch 121, which is originally designed for specifying the number of digits for rounding of numerical values in the calculation result calculated by the electronic device 1 by the switching positions of the operator 121a, is used. Thus, it is possible to more easily select an external device to which connection is desired from a plurality of external devices without adding additional hardware.

According to the embodiments described above, when the CAL mode is executed, the slide switch 121 is used to specify the number of digits for rounding a numerical value in the calculation result, and when the PC mode is executed, the slide switch 121 is not used to specify the number of digits for rounding the calculation result. Because of this, it can be used in either CAL mode or PC mode, depending on the purposes, without adding additional hardware. As a result, it is possible to more easily select an external device to which connection is desired from a plurality of external devices.

According to the embodiments described above, since the switching position of the operator 121a is a slide switch that is specified by the stop position of the operator 121a, an external device to which connection is desired can be selected from a plurality of external devices without adding additional hardware.

It will be apparent to those skilled in the art that various modifications and variations can be made in the present invention without departing from the spirit or scope of the invention. Thus, it is intended that the present invention cover modifications and variations that come within the scope of the appended claims and their equivalents. In particular, it is explicitly contemplated that any part or whole of any two or more of the embodiments and their modifications described above can be combined and regarded within the scope of the present invention.

What is claimed is:

1. An electronic device, comprising:
a switch having an operator that can assume one of a plurality of positions;
a wireless communication unit; and
a control unit,
wherein in response to detecting that a position of the operator is switched, the control unit selects an external device associated with the switched position of the operator from among a plurality of external devices and establishes a connection to the selected external device via the wireless communication unit.

2. The electronic device according to claim 1, wherein in response to detecting that the position of the operator is changed during connection with the external device, the control unit selects and connects to an external device different from the external device currently connected, based on the changed position of the operator.

3. The electronic device according to claim 1, further comprising a storage unit that stores the plurality of positions of the operator and pairing information of the plurality of external devices in association with each other,
wherein the control unit reads pairing information associated with the switched position of the operator from the storage unit, and establishes the connection to the external device based on the read pairing information.

4. The electronic device according to claim 1, further comprising a numeric keypad,
wherein the control unit performs a calculation function that performs calculations based on operations on the numeric keypad, and a transmission function that causes the transmission unit to transmit numerical data specified based on operations on the numeric keypad to the external device connected, and
wherein the switch is a switch that specifies the number of digits for rounding of numerical values in calculation results by the calculation function by the position of the operator.

5. The electronic device according to claim 4, wherein in case of the calculation function is performed, the switch functions to specify the number of digits for rounding a numerical value in the calculation results in the calculation function, and in case of the transmission function is performed, the switch functions to specify the external device to be connected and does not function to specify the number of digits for rounding a numerical value in the calculation results in the calculation function.

6. The electronic device according to claim 5, wherein the switch is a slide switch that specifies one of the plurality of positions by a stop position of the operator.

7. A method to be performed by a control unit in an electronic device that includes, in addition to the control unit, a switch having an operator that can specify one of a plurality of positions; and a wireless communication unit, the method comprising, via the control unit:
in response to detecting that a position of the operator is switched, selecting an external device associated with the switched position of the operator from among a plurality of external devices; and
establishing a connection to the selected external device via the wireless communication unit.

8. The method according to claim 7, further comprising, via the control unit, in response to detecting that the position of the operator is changed during connection with the external device, selecting and connecting an external device different from the external device currently connected, based on the changed position of the operator.

9. The method according to claim 7, wherein the electronic device further comprises a storage unit that stores the plurality of positions of the operator and pairing information of the plurality of external devices in association with each other, and
wherein the selecting of an external device and the establishing of the connection include reading pairing information associated with the switched position of the operator from the storage unit, and establishing the connection to the external device via the wireless communication unit based on the read pairing information.

10. A non-transitory computer readable storage medium storing a program to be performed by a control unit in an electronic device that includes, in addition to the control unit, a switch having an operator that can specify one of a plurality of positions; and a wireless communication unit, the program causing the control unit to perform the following:
in response to detecting that a position of the operator is switched, selecting an external device associated with the switched position of the operator from among a plurality of external devices; and
establishing a connection to the selected external device via the wireless communication unit.

11. The non-transitory computer readable storage medium according to claim 10, wherein in response to detecting that the position of the operator is changed during connection with the external device, the program causes the control unit to select and connect an external device different from the external device currently connected, based on the changed position of the operator.

12. The non-transitory computer readable storage medium according to claim 10,
wherein the electronic device further comprises a storage unit that stores the plurality of positions of the operator and pairing information of the plurality of external devices in association with each other, and
wherein the selecting of an external device and the establishing of the connection include reading pairing information associated with the switched position of the operator from the storage unit, and establishing the connection to the external device via the wireless communication unit based on the read pairing information.
